(19) United States
(12) Patent Application Publication
(10) Pub. No.: US 2014/0107924 A1
(43) Pub. Date: Apr. 17, 2014

(54) Information Device and Information System for a Vehicle

(71) Applicant: Bayerische Motoren Werke Aktiengesellschaft, Muenchen (DE)

(72) Inventor: Marcello TAVA, Muenchen (DE)

(73) Assignee: Bayerische Motoren Werke Aktiengesellschaft, Muenchen (DE)

(21) Appl. No.: 14/141,521

(22) Filed: Dec. 27, 2013

Related U.S. Application Data
(63) Continuation of application No. PCT/EP2012/061978, filed on Jun. 21, 2012.

(30) Foreign Application Priority Data
Jun. 29, 2011 (DE) 10 2011 078 261.3

(51) Int. Cl. G01C 21/34

(52) U.S. Cl. CPC G01C 21/3407
USPC 701/533

(57) ABSTRACT

A vehicle information system includes a determination unit configured to determine, as a function of a determined route, at least one stop of a public transport vehicle within a predefined maximal distance to the route, and to generate a signal for visually indicating at least a partial number of the determined stops on a display unit. A selection unit is configured to signal, as a function of, in each case, one predefined detected angle-of-rotation change of a rotationally movable input element, the determined stops corresponding to a predefined sequence, each individually as having been selected, and, as a function of a predefined user input, to generate a signal for visually indicating on the display unit of a respective travel route of at least one transport vehicle line which has a stopping point at the selected stop.

### CROSS REFERENCE TO RELATED APPLICATIONS

This application is a continuation of PCT International Application No. PCT/EP2012/061978, filed Jun. 21, 2012, which claims priority under 35 U.S.C. §119 from German Patent Application No. 10 2011 078 261.3, filed Jun. 29, 2011, the entire disclosures of which are herein expressly incorporated by reference.

### BACKGROUND AND SUMMARY OF THE INVENTION

The invention relates to an information device and an information system for a vehicle.

Demand is growing in the automobile environment for high-quality information systems which provide the user, particularly a vehicle occupant, with information in a comfortable manner. Navigation systems, for example, are widely used in modern motor vehicles. The navigation systems are designed for determining a route for the vehicle from the starting point to the destination point as a function of inputted starting and destination points. In this case, the route can be optimized with respect to selectable criteria, for example, the fastest route.

Particularly in large metropolitan areas, it is preferable for vehicle users, particularly in view of a very high traffic volume with related traffic congestion situations, in certain situations, to cover a portion of the route between the starting and destination point by use of public transport vehicles.

It is an object of the invention to make available an information device and an information system which is comfortable and contributes to a safe driving operation.

This and other objects are achieved according to the invention, wherein according to a first aspect, the invention is characterized by an information device for a vehicle having a route determination unit which is designed for determining, as a function of a provided starting point and as a function of a provided destination point, a route from the starting point to the destination point, and for generating a signal for visually signaling at least a portion of the determined route on a display unit. Thus, the route and, as a result, a corresponding visual representation of a digital map detail can be signaled on the display unit.

The information device further comprises a determination unit which is designed for determining, as a function of the determined route, at least one stop of a public transport vehicle within the predefined maximal distance from the route, and for generating a signal for the visual signaling of at least a partial number of the determined stops on the display unit. In this case, the determination unit can form a client of a server/client structure, and the server can also be arranged outside the vehicle, and a communication can take place by way of suitable communication interfaces.

The information device further comprises a selection unit which is designed for signaling, as a function of, in each case, one predefined detected angle-of-rotation change of a rotatory movable input element of a rotating actuator, the determined stops corresponding to a predefined sequence, each individually as having been selected, and, as a function of a predefined user input, for generating a signal for the visual signaling on the display unit of a respective travel route of at least one transport vehicle line which has a stopping point at the selected stop. This takes place such that the visual signaling of the respective travel route is superimposed on the transport vehicle line to the determined signaled route or the signaled portion of the determined route.

Thus, concerning respective individual stops of the determined stops, the pertaining information can be reliably visually output by particularly simple user actions—turning of the rotationally movable input element and then implementing the predefined user input, such as pressing a key element—with respect to the travel route of at least one of the transport vehicle lines at the selected stop, without, for this purpose significantly diverting the driver's attention from the driving situation.

Furthermore, by signaling the travel routes of the respective transport vehicle line, relevant information concerning the respective transport vehicle line is offered to the driver in a compressed and easily understandable fashion, and can thereby easily assist him in making a decision as to the point at which he may possibly change from his vehicle to a public transport vehicle, in order to reach the predefined destination point.

According to an advantageous further development of the first aspect, the selection unit is further designed for selecting that or those transport vehicle lines which have a stopping point at the selected stop and a further stopping point at a further stop which is situated within a predefined distance to the destination point. In this context, the selection unit is further designed for generating a signal for the visual signaling on the display unit of only the respective travel route of the selected transport vehicle line or lines, specifically such that the visual signaling of the respective travel route takes place in a superimposed manner with respect to the signaled determined route or the signaled portion of the route.

In this manner, the signaled information can be reduced to the transport vehicle line(s) that is/are probably most relevant or are most relevant to the vehicle user and his attention is thereby diverted from the current traffic situation to only a particularly low degree.

According to an advantageous further development, the selection unit is designed for selecting that or those transport vehicle line(s) that have a stopping point at the selected stop and a stopping point at a further stop which is situated within a predefined distance to the destination point, and for generating a signal for the visual signaling on the display unit of the respective travel route of the selected transport vehicle line or lines, specifically such that the visual signaling of the respective travel route takes place in a superimposed manner with respect to the signaled determined route or the signaled portion of the route and takes place in a highlighted manner in comparison to determined but not selected travel routes.

In this manner, the information that can be rapidly perceived by the vehicle user can be reduced to the transport vehicles lines that are probably the most relevant or are the most relevant to him, and his attention is thereby diverted to only a particularly low degree from the current traffic situation.

According to a second aspect, the invention is characterized by an information system for a vehicle having the information device according to the first aspect and a display unit and a rotating actuator with a rotationally movable input element. With respect to its advantages and its advantageous further developments, the second aspect corresponds to the first aspect.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a block diagram view of an information system for a vehicle; and

FIGS. 2A to 2C are views of various visual output situations on a visual display unit of the information system.

### DETAILED DESCRIPTION OF THE DRAWINGS

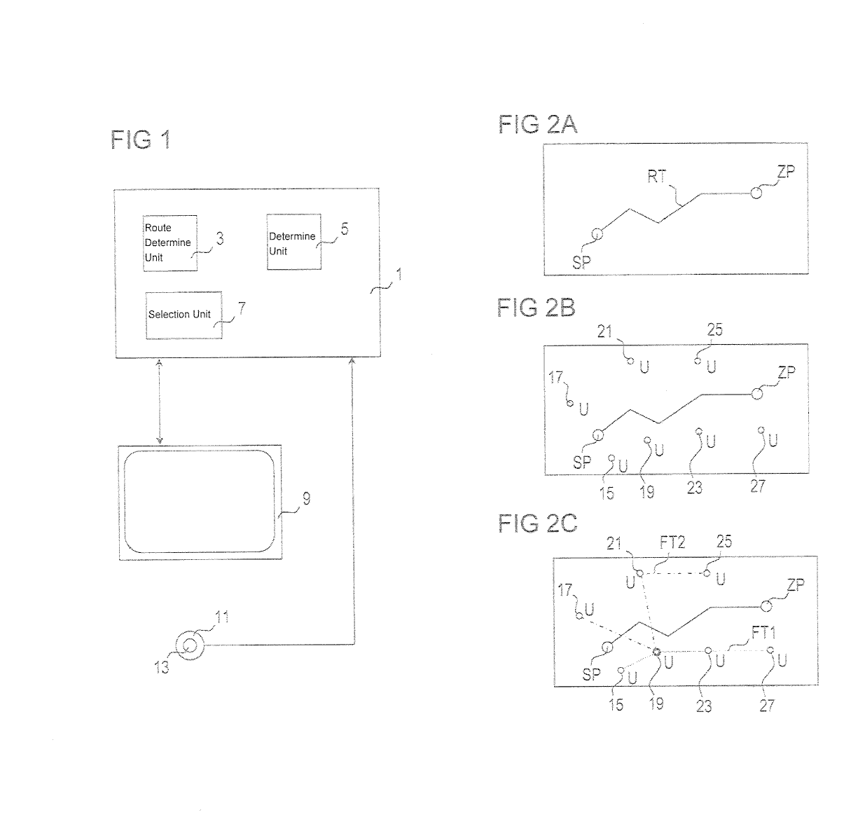

Referring to FIG. 1, an information system for a vehicle includes an information device 1, which comprises, in particular, a computing unit having a data and program memory and at least one correspondingly predefined processor. Functionally, the information device 1 comprises a route determination unit 3, a determination unit 5 and a selection unit 7.

Furthermore, a display unit 9 is assigned to the information device 1, which display unit 9 particularly is a visual display unit and may, for example, be a so-called head unit. In addition, a rotating actuator 11 is provided which has a rotationally movable input element 13 which may be designed, for example, as a rotary button and can therefore be operated by a simple rotating by the vehicle user. However, the rotationally movable input element 11 may also be designed in a different fashion, which is known to a person skilled in the art in connection with rotating actuators, thus, for example, as a rotary knob. Furthermore, the rotating actuator preferably also includes a key unit which may, for example, be designed such that, by pressing on the rotationally movable input element 11, a corresponding key switch is actuated. The rotating actuator 13 may, for example, be arranged in a center console of the vehicle.

The route determination unit 3 is designed for determining, as a function of a provided starting point SP and a destination point ZP, a route RT from the starting point SP to the destination point ZP, and for generating a signal for visually signaling at least a portion of the determined route on the display unit 9 (see FIGS. 2a-2c). The starting point SP and also the destination point ZP can be input by the vehicle user in a suitable manner; particularly the starting point SP can also be predefined by a current detected position of the vehicle. For detecting the position, for example, a position determination unit, for example, based on the GPS, is provided.

The determination of the route RT takes place particularly by taking into account at least one predefined optimization criterion, such as the fastest route, the most cost-effective route, the route with the most favorable consumption, and the like.

The determination unit 5 is designed for determining, as a function of the determined route RT, at least one stop 15, 17, 19, 21, 23, 25, 27 of a public transport vehicle within a predefined maximal distance from the route RT. It is further designed for generating a signal for the visual signaling of at least a partial number of determined stops 15 to 27 on the display unit 9. The stops 15 to 27 are, for example, signaled by means of a small circle or a circular ring and, if required, by means of an additional symbol, such as a “U”, which may, for example, indicate a U-Bahn (subway).

The maximal distance to the route RT is preferably predefined such that a suitable number of stops 15 to 27 is determined in this manner, which can be reached without any considerable departure from the determined route RT. When determining the stops 15 to 27, it may also be taken into account whether corresponding parking possibilities, such as a park and ride parking lot, are assigned to a respective stop 15 to 27. Beyond that, it is also basically contemplated that the type of the respective public transport vehicle is predefined by the user. The type of the public transport vehicle may, for example, be a subway, a light railway, a regional train, a long-distance train, a bus, a streetcar, and the like.

The determination unit 5 may form a client of a server/client structure, and the server may also be arranged outside the vehicle, and a communication may take place by way of suitable communication interfaces. In this case, the determination unit 5 is designed for transmitting the determined route RT by way of the communication interface to the server. In this case, the server itself is designed for computing, in response to the transmitted route RT, the stops 15, 17, 19, 21, 23, 25, 27 of the public transport vehicle within a predefined maximal distance from the route RT and for transmitting them to the determination unit. This preferably takes place in the KML (Keyhole Markup Language) format. An interpreter for KML elements will then be developed in the determination unit.

The selection unit 7 is designed for signaling, as a function of, in each case, one predefined detected angle-of-rotation change of the rotationally movable input element 13 of the rotating actuator, the determined stops 15 to 27, each individually as having been selected, corresponding to a predefined sequence. For this purpose, the respective stop can, for example, be visually highlighted on the display unit 9 in comparison to the other stops 15 to 27, thus, for example, by a correspondingly deviating coloring of the circle or circular ring or, for example, by a flashing of the circle or of the circular ring.

The predefined angle-of-rotation change may be a suitable angle-of-rotation change, depending on the further development of the rotating actuator, thus, for example, the angle of rotation of the input element rotationally movable to a subsequent engagement point, and may, for example, amount to between 5 and 45°.

The sequence may advantageously be predefined such that, while the rotating direction remains the same, with successive predefined detected angle-of-rotation changes, one after the other, those determined stops 15 to 27 are signaled as having been selected, which succeed one another corresponding to the course of the determined route. Thus, they may be signaled as having been selected, for example, in the sequence 15, 17, 19, 21, 23, 25, 27. Preferably, in the case of a reversal of the moving direction of the rotationally movable input element 13, a reverse sequence of the signaling of the stop 15 to 17 takes place.

As a function of a predefined user input, a signal is generated for the visual signaling on the display unit 9 of a respective travel route of at least one of the transport vehicle lines that have a stopping point at the selected stop 15 to 27. This takes place in that the visual signaling of the respective travel route FT1, FT2 takes place in a superimposed manner with respect to the signaled determined route RT or the signaled portion of the route RT. The predefined user input is, for example, a pressing of the rotationally movable input element 13 in the direction of its axis of rotation, which causes a switching operation on a corresponding key element. The respective travel routes FT1, FT2 of one or more transport vehicle lines that have a stopping point at the selected stop 15 to 27, will thereby be visually signaled on the display unit 9, specifically in a superimposed manner with respect to the signaled determined route or the signaled portion of the route RT, which makes it possible for the vehicle user to make a selection of the possibly suitable transport vehicle line, which requires little attention.

In addition, it may optionally be provided that the visual signaling of the respective travel routes FT1, FT2 takes place in the respective symbol colors which are used by the transport vehicle operators.

Furthermore, it may optionally be provided that, by way of a predefined further user input, a schedule assigned to the respective transport vehicle line is visually output. In this case, if necessary, the output takes place by the buildup of a new video screen content on the display unit without the displaying of the route RT or of the travel route FT1, FT2 and of the possibly signaled digital map data, thus, for example, only in a text field.

The selection unit 7 is optionally also designed for selecting that or those transport vehicle lines which have a stopping point at the selected stop 15 to 27 and have a stopping point at a further stop 15 to 27 that is situated within a predefined distance to the destination point. The predefined distance is advantageously selected such that it is shorter than or equal to the predefined maximal distance to the route RT. In principle, the maximal distance and also the predefined distance to the destination point ZP can be fixedly predefined or can be predefined by the vehicle user.

Optionally, the selection unit 7 is also designed for generating a signal for the visual signaling on the display unit 9 of only the respective travel route FT1, FT2 of the selected transport vehicle lines, specifically such that the visual signaling of the respective travel route FT1, FT2 takes place in a superimposed manner with respect to the signaled determined route RT or the signaled portion of the route RT. For example, only the travel route FT1 is visually signaled.

Optionally, the selection unit 7 may also be designed for selecting that or those transport vehicle lines which have a stopping point at the selected stop 15 to 27 and a stopping point at a further stop 15 to 17 which is within a predefined distance to the destination point ZP, and for generating a signal for the visual signaling on the display unit 9 of the respective travel route FT1, FT2 of the selected transport vehicle lines, specifically such that the visual signaling of the respective travel route FT1, FT2 takes place in a superimposed manner with respect to the signaled determined route RT or of the signaled portion of the route RT and takes place in a highlighted manner in comparison to the determined but not selected travel routes. In this case, travel route FT1, for example, is signaled by means of a wider line in comparison to travel route FT2.

Optionally, the server may also be designed for transmitting travel routes of the transport vehicle lines by way of the communication interfaces to the client. This preferably also takes place in the KML format. Furthermore, the server may also be designed for transmitting assigned stop names and/or schedules by way of the communication interfaces to the client. This preferably takes place in the XML format.

FIG. 2A illustrates a visual output on the display unit 9, on which the starting point SP, the destination point ZP and the determined route RT are shown. Preferably, digital map information is also visually signaled in the background, which may, for example, comprise streets.

In addition to the information illustrated in FIG. 2A, FIG. 2B also visually indicates the determined stops 15 to 27. In addition to the information of FIG. 2B, in FIG. 2C, the travel routes FT1, FT2 of those transport vehicle lines are visually indicated which have a stopping point at stop 19.

Furthermore, in principle, the names of the respective stops 15 to 27 can also be indicated on the display unit 9.

In addition, optionally, by means of a further predefined user input, the determination of the stops 15 to 27 and/or the signaling of the travel routes FT1, FT2 of the transport vehicle lines may be activated or deactivated.

### REFERENCE SYMBOLS

1 Information device
3 Route determination unit
5 Determination unit
7 Selection unit
9 Display unit
11 Rotating actuator
13 Rotationally movable input element
SP Starting point
ZP Destination point
RT Determined route
15, 17, 19, 21, 23, 25, 27 determined stop
selected stop
FT1, FT2 Travel route

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An information device for a vehicle, comprising:
a route determination unit operatively configured to determine, as a function of a provided starting point and a destination point, a route from the starting point to the destination point, and to generate a signal for visually indicating at least a portion of the determined route on a display unit;
a determination unit operatively configured to determine, as a function of the determined route, at least one stop of a public transport vehicle within a predefined maximal distance to the determined route, and to generate a signal for visually indicating at least a partial number of determined stops of the public transport vehicle on the display unit;
a selection unit operatively configured to signal, as a function of, in each case, one predefined detected angle-of-rotation change of a rotationally movable input element of a rotating actuator, the determined stops corresponding to a predefined sequence, each individually as having been selected, and, as a function of a predefined user input, to generate a signal for visually indicating on the display unit of a respective travel route of at least one transport vehicle line which has a stopping point at the selected stop, wherein the visual indication of the respective travel route takes place in a superimposed manner with respect to the indicated determined route or an indicated portion of the determined route.

2. The information device according to claim 1, wherein:
the selection unit is further operatively configured to select that, or those, transport vehicle lines which have a stopping point at the selected stop and a stopping point at a further stop which is located within a predefined distance to the destination point, and to generate a signal for visually indicating on the display unit of only the respective travel route of the selected transport vehicle line or lines, wherein the visual indicating of the respective travel route takes place in a superimposed manner with respect to the indicated determined route or the indicated portion of the route.

3. The information device according to claim 1, wherein:
the selection unit is further operatively configured to select that, or those, transport vehicle lines which have a stopping point at the selected stop and a stopping point at a further stop which is located within a predefined distance to the destination point, and to generate a signal for visually indicating on the display unit of the respective travel route of the selected transport vehicle line or lines, wherein the visual indication of the respective travel route takes place in a superimposed manner with respect to the indicated determined route or the indicated portion of the route, and takes place in a highlighted manner in comparison to the determined but not selected travel routes.

4. An information system for a vehicle, comprising:
a display unit;
a rotating actuator having a rotationally movable input element;
an information device comprising:
a route determination unit operatively configured to determine, as a function of a provided starting point and a destination point, a route from the starting point to the destination point, and to generate a signal for visually indicating at least a portion of the determined route on a display unit;
a determination unit operatively configured to determine, as a function of the determined route, at least one stop of a public transport vehicle within a predefined maximal distance to the determined route, and to generate a signal for visually indicating of at least a partial number of determined stops of the public transport vehicle on the display unit;
a selection unit operatively configured to signal, as a function of, in each case, one predefined detected angle-of-rotation change of a rotationally movable input element of a rotating actuator, the determined stops corresponding to a predefined sequence, each individually as having been selected, and, as a function of a predefined user input, to generate a signal for visually indicating on the display unit of a respective travel route of at least one transport vehicle line which has a stopping point at the selected stop, wherein the visual indication of the respective travel route takes place in a superimposed manner with respect to the indicated determined route or an indicated portion of the determined route.

5. The information system according to claim 4, wherein:
the selection unit is further operatively configured to select that, or those, transport vehicle lines which have a stopping point at the selected stop and a stopping point at a further stop which is located within a predefined distance to the destination point, and to generate a signal for visually indicating on the display unit of only the respective travel route of the selected transport vehicle line or lines, wherein the visual indicating of the respective travel route takes place in a superimposed manner with respect to the indicated determined route or the indicated portion of the route.

6. The information system according to claim 4, wherein
the selection unit is further operatively configured to select that, or those, transport vehicle lines which have a stopping point at the selected stop and a stopping point at a further stop which is located within a predefined distance to the destination point, and to generate a signal for visually indicating on the display unit of the respective travel route of the selected transport vehicle line or lines, wherein the visual indication of the respective travel route takes place in a superimposed manner with respect to the indicated determined route or the indicated portion of the route, and takes place in a highlighted manner in comparison to the determined but not selected travel routes.
